(19) United States
(12) Patent Application Publication
(10) Pub. No.: US 2015/0342404 A1
(43) Pub. Date: Dec. 3, 2015

(54) Grandle

(71) Applicant: Candice Ann Beu-Long, Las Vegas, NV (US)

(72) Inventor: Candice Ann Beu-Long, Las Vegas, NV (US)

(21) Appl. No.: 14/724,664

(22) Filed: May 28, 2015

Related U.S. Application Data
(60) Provisional application No. 62/005,058, filed on May 30, 2014.

(51) Int. Cl. A47J 37/07; E05B 1/00

(52) U.S. Cl. CPC A47J 37/0786; E05B 1/0015; E05B 1/0061

(57) ABSTRACT

A fitted grill handle cover to protect against burning your hands is disclosed. The handle cover is always on, and fits comfortably around the handle. This handle cover is machine washable, reversible and looks great.

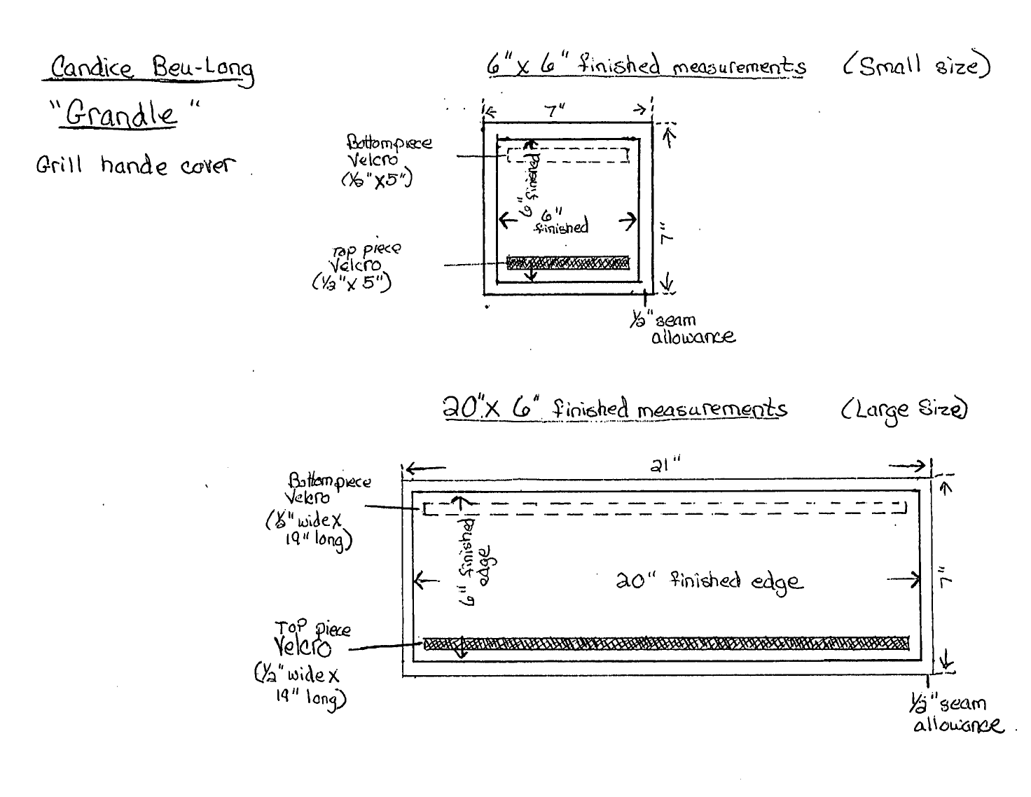

“The Grandle”, a fitted grill handles cover to protect against burning your hands.

### BACKGROUND OF THE INVENTION

Problem Solved: In hot climates the grill handles get very hot to the touch even when not in use. People burn their hands while opening the grill to cook.

The oven mitts and gloves are bulky, hot or get misplaced while cooking outside.

The handle cover is always on, and fits comfortably around the handle. This handle cover is machine washable, reversible and looks great.

### DETAILED DESCRIPTION OF THE INVENTION

As stated above, in hot climates the grill handles get very hot to the touch even when not in use. People burn their hands while opening the grill to cook. The invention claimed here solves this problem.

This covers the metal handle to protect the skin from coming into contact with the hot metal.

The claimed invention differs from what currently exists. The only things to protect the skin now are oven mitts or gloves. This stays in place on the handle at all times.

This invention is an improvement on what currently exists. The only things to protect the skin now are oven mitts or gloves. This stays in place on the handle at all times.

It's difficult to cook while wearing a mitt or glove. While looking for them your food can burn.

The handle cover is always on, and fits comfortably around the handle. This handle cover is machine washable, reversible and looks great.

Also, this can be used wrap around door handles, electrical cords to cover them.

The Version of The Invention Discussed Here Includes:
1. 2 pieces of fabric
2. 1 piece of (low loft) polyester batting
3. Velcro
4. Thread

Relationship Between The Components:

Step #1 is the covering and beauty of the invention and will cover Step #2. Step #2 is a thermal barrier between the metal and skin. Step #3 holds the top and bottom together when wrapped around the handle. Step #4 is used to sew each part together securely.

How The Invention Works:

The outer fabric can be any design the consumer wants, this makes it very appealing. The cover is filled with batting to insulate and hold the heat inside to protect from burning the hand when opening the grill lid. The Velcro allows the cover to be wrapped tightly around the grill handle and stay in place. The fabric used is machine washable and used on both sides making the cover reversible if one side is damaged by sun, dirt or weather.

How To Make The Invention:

Cut and sew Velcro pieces to the right side, bottom edge of the both pieces of fabric leaving space for seam allowance. Velcro needs to be matched on both sides to connect evenly. Sew the hook sides to one fabric piece and the fastening side to the other fabric piece. Sew both pieces of fabric together by placing the right sides together with the Velcro at opposite ends. The Velcro must match when wrapped around the handle. Sew 3 of the sides together. Turn right side out and insert the polyester batting piece to fit from side to side. Fold the fabric inside at seam allowance, press and stitch the outer edges to secure all sides.

The batting used between the fabrics is necessary to form a barrier between the heat and persons hand. Velcro is necessary to form the perfect fit around the grill handle. A flame retardant fabric can be used to be sure the handle cover is resistant to flame but the fabric isn't as attractive.

The grill handle cover can be made in different sized to be used by different sized handles.

How To Use The Invention:

Wrap the handle cover around the grill handle by attaching the Velcro pieces, before opening the grill top. The handle will keep your hands safe from burning on the hot metal surface. When it is dirty, wash in cold water and lay flat to dry.

Also, it can create: This can be used to wrap around door handles, electrical cords to cover them.

I claim:

1. A handle wrap creates a protective barrier between the hot handle surface and the person's hand by using a piece of batting between the exterior fabric pieces, therefore making it safer.

2. A handle wrap stays in place, tightly wrapped around the hot handle with Velcro closure.

3. The handle wrap is easily removable to clean; it is machine washable and reversible.

4. The various fabric choices make the handle wrap very appealing.
